(19) United States
(12) Patent Application Publication
(10) Pub. No.: US 2002/0057273 A1
(43) Pub. Date: May 16, 2002

(54) METHOD OF AND APPARATUS FOR REPRODUCING FACIAL EXPRESSIONS

(76) Inventors: SATOSHI IWATA, KAWASAKI-SHI (JP); TAKAHIRO MATSUDA, KAWASAKI-SHI (JP)

Correspondence Address: JAMES D HALSEY, JR., STAAS & HALSEY, 700 ELEVENTH STREET N W, SUITE 500, WASHINGTON, DC, 20001

(21) Appl. No.: 09/127,600

(22) Filed: Jul. 31, 1998

(30) Foreign Application Priority Data
Mar. 5, 1998 (JP) 10-53683

(51) Int. Cl. G06T 13/00

(52) U.S. Cl. 345/473

(57) ABSTRACT

Facial expressions to present information are represented by reproducing a subordinate frame representative of another facial expression image from a basic frame representative of a basic facial expression image. An apparatus for reproducing facial expression images has a storage unit for storing data of the basic frame which represents shapes and positions of part patterns of the basic facial expression image, and data of the subordinate frame which represents a relative positional relationship between a plurality of change points of respective part patterns of the other facial expression image, and a reproducing unit for reproducing the facial expression image of the subordinate frame from the relative positional relationship between the change points of the subordinate frame corresponding to a designated facial expression and the data of the basic frame. Since the data of the subordinate frame may be reduced, a storage capacity for storing facial expression images including basic and subordinate frames may be reduced.

### BACKGROUND OF THE INVENTION

1. Field of the Invention

The present invention relates to a method of and an apparatus for reproducing facial expressions to present information, and more particularly to a method of and an apparatus for reproducing facial expressions with face images.

2. Description of the Related Art

It has been customary to express command, warning, and help information with characters on computers such as personal computers or the like. However, characters are not suitable for presenting information representing feelings and information representing degrees of something.

It has been attempted to present facial expressions with face images. For example, a two-dimensional deformed face image is varied to present feelings and degrees. Such a two-dimensional deformed face image is capable of indicating system statuses, hints for problems, and operation instructions. For reproducing images of facial expressions, it is required to generate a wide variety of images of facial expressions.

FIGS. 11 and 12 of the accompanying drawings illustrate conventional processes of generating images of facial expressions.

FIG. 11 shows a facial expression known as a smile. Presenting a facial expression as a smile requires facial expression images of n frames ranging from a unit facial expression F0 via unit facial expressions F1, F2, F3 to a unit facial expression Fn. In order to register these facial expression images, the unit expressions are drawn as cell pictures, and a computer reads the cell pictures and registers the read images in a memory.

For reproducing the facial expression, the computer reads the stored images of the frames from the memory and reproduces the images. Heretofore, each of the images of the cell pictures is broken up into dots, and the dots are stored in the memory.

The storage of the images in the form of dots allows the cell pictures to be reproduced highly accurately. However, one problem is that a huge storage capacity is needed to store a series of frames of facial expression images.

FIG. 12 schematically shows a face whose features are expressed by patterns of various parts including eyes, a nose, and a mouth. There has been known a method of designating positions of those parts (the eyes, the nose, and the mouth) of the face. According to the known method, positions ESO, ENSO, MNSO, MWO of the part patterns (the eyes, the nose, and the mouth) of the face are designated to vary the facial expression of the face.

According to the known method shown in FIG. 12, while the positions of the part patterns (the eyes, the nose, and the mouth) can be changed, the eyes and the mouth cannot be changed in shape unlike the facial expressions shown in FIG. 11. Therefore, it is difficult to produce a variety of facial expressions.

### SUMMARY OF THE INVENTION

It is an object of the present invention to provide a method of and an apparatus for reproducing facial expressions with a reduced storage capacity for storing facial expression images.

Another object of the present invention is to provide a method of and an apparatus for reproducing a wide variety of different facial expressions with a small storage capacity.

To achieve the above objects, an apparatus and a method in accordance with the present invention reproduce a subordinate frame representative of another facial expression image from a basic frame representative of a basic facial expression image. The apparatus for reproducing facial expression images comprises storage means for storing data of the basic frame which represents shapes and positions of part patterns of the basic facial expression image, and data of the subordinate frame which represents a relative positional relationship between a plurality of change points of respective part patterns of the other facial expression image, and reproducing means for reproducing the facial expression image of the subordinate frame from the relative positional relationship between the change points of the subordinate frame corresponding to a designated facial expression and the data of the basic frame.

According to the present invention, a subordinate frame of a facial expression image is reproduced from a basic frame. For reproducing the subordinate frame, shapes and positions of part patterns of the basic facial expression image are stored as data of the basic frame, and a relative positional relationship between a plurality of change points of respective part patterns of the other facial expression image is stored as data of the subordinate frame. The facial expression image of the subordinate frame is reproduced from the relative positional relationship between the change points of the subordinate frame corresponding to a designated facial expression and the data of the basic frame.

Since the stored data of the subordinate frame comprises only data representative of the relative positional relationship between change points, a storage capacity required for storing the facial expression image of the subordinate frame may greatly be reduced. Because the change points of the part patterns of the facial expression images are employed, it is possible to present a wide variety of many facial expressions.

Other features and advantages of the present invention will become readily apparent from the following description taken in conjunction with the accompanying drawings.

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principle of the invention, in which:

FIG. 1 is a block diagram of an apparatus according to an embodiment of the present invention;

FIG. 2 is a flowchart of a registering sequence carried out by the apparatus shown in FIG. 1;

FIG. 3 is a diagram showing unit facial expressions used in the registering sequence shown in FIG. 2;

FIG. 4 is a diagram showing facial expression data used in the registering sequence shown in FIG. 2;

FIG. 5 is a diagram illustrative of facial expression transition data shown in FIG. 4;

FIG. 6 is a diagram illustrative of other facial expression transition data shown in FIG. 4;

FIG. 7 is a diagram illustrative of still other facial expression transition data shown in FIG. 4;

FIG. 8 is a diagram illustrative of yet still other facial expression transition data shown in FIG. 4;

FIG. 9 is a flowchart of a reproducing sequence carried out by the apparatus shown in FIG. 1;

FIG. 10 is a diagram illustrative of another embodiment of the present invention;

FIG. 11 is a diagram illustrative of a conventional process of generating images of facial expressions;

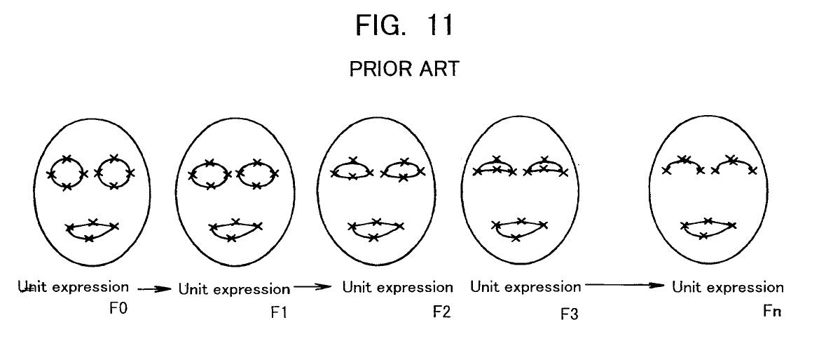

FIG. 12 is a diagram illustrative of another conventional process of generating images of facial expressions.

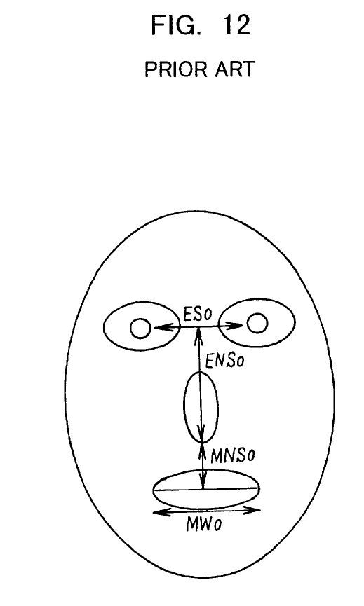

### DETAILED DESCRIPTION OF THE PREFERRED EMBODIMENTS

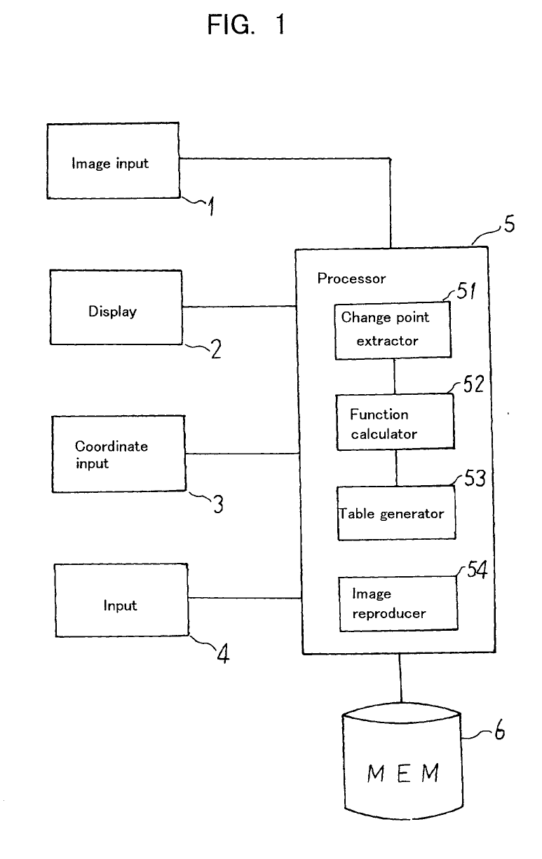

As shown in FIG. 1, an apparatus according to an embodiment of the present invention has an image input unit 1 for entering images such as of cell pictures drawn by animators, a display unit 2 for displaying entered images and reproduced images, a coordinate input unit 3 for entering change points of displayed images, and an input unit 4 for entering attributes of change points and commands.

The apparatus also has a processing unit 5 comprising a processor. The processing unit 5 executes a registering process and a reproducing process described later on. The processing unit 5 has a change point extractor 51 for extracting change points of facial expression images, a change point function calculator 52 for calculating functions between change points, a table generator 53 for generating a storage table for facial expression data, and an image reproducer 54 for reproducing images. The change point extractor 51, the change point function calculator 52, the table generator 53, and the image reproducer 54 represent functions that are performed by the processor 5. The apparatus further includes a storage unit 6 for storing generated facial expression data.

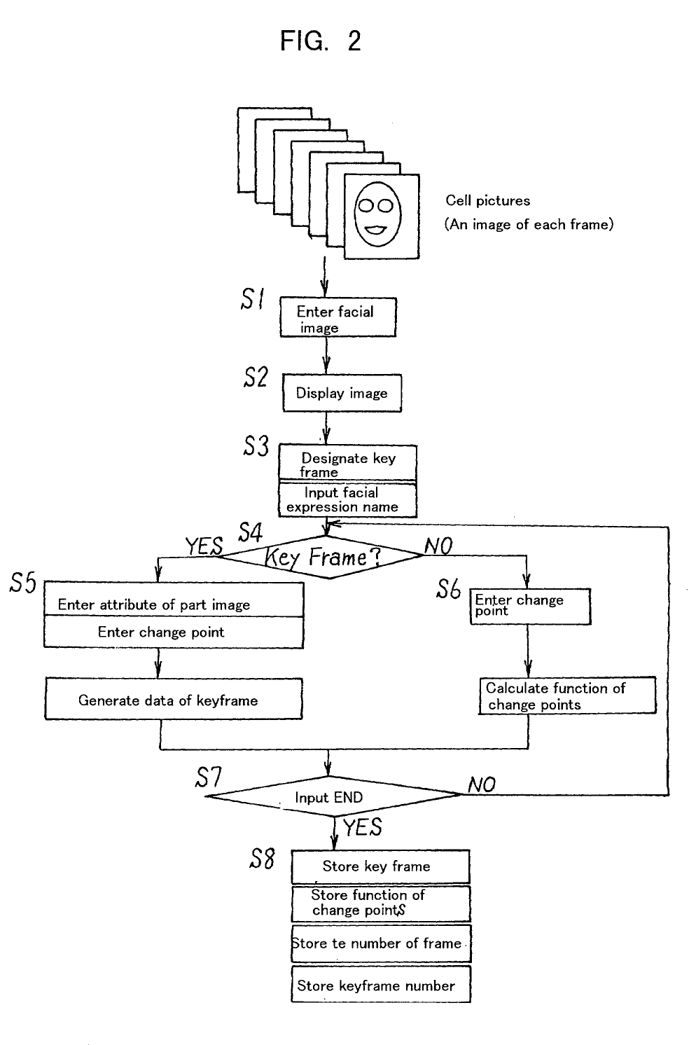

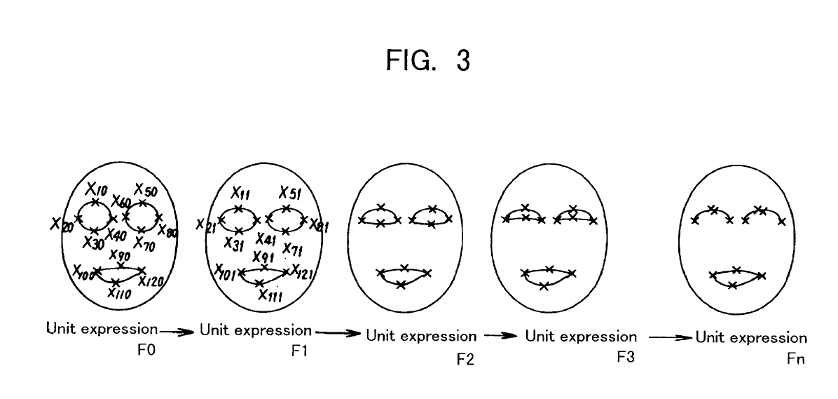

A registering process for registering facial expression images will be described below with reference to FIG. 2. In the registering process, a face image representing a smile which is composed of N unit facial expressions F0-Fn shown in FIG. 3 is employed. In FIG. 3, each of the unit facial expressions F0-Fn of the face image comprises two eyes and a single mouth. In FIG. 2, numerals with a prefix “S” represent step numbers.

(S1) Cell pictures of deformed face images are prepared. For example, cell pictures of unit facial expressions F0-Fn shown in FIG. 3 are prepared. These cell pictures are successively entered by the image input unit 1, producing images of frames.

(S2) The images of frames are displayed on the display unit 2.

(S3) A key frame (basic frame) is designated through the input unit 4. Then, a facial expression name is entered through the input unit 4. In FIG. 3, the key frame is the unit facial expression F0, and the facial expression name is a smile.

(S4) It is determined whether the next frame for image processing is the key frame or not.

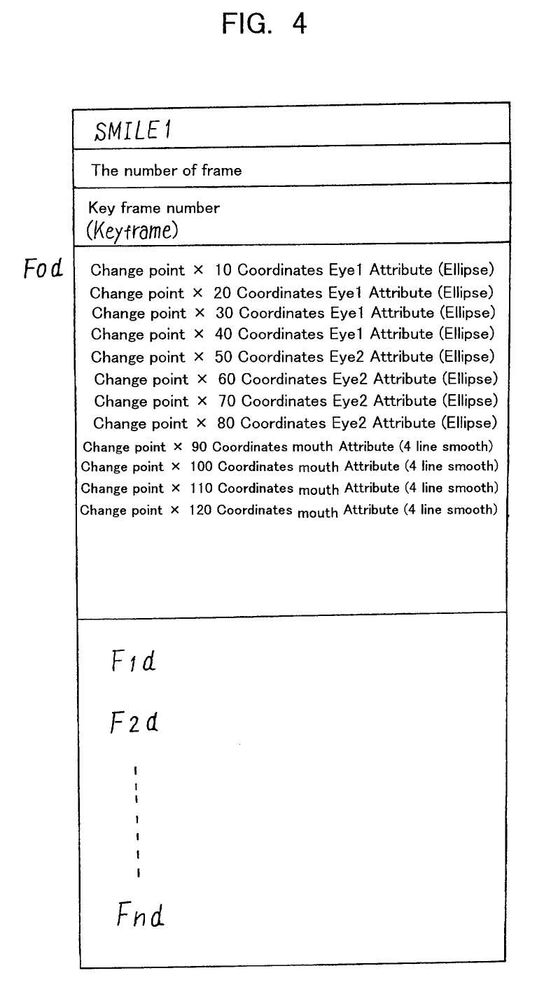

(S5) When the next frame is the key frame, then the image of the key frame is displayed. The operator designates change points of the part patterns of the facial expression image through the coordinate input unit 3. The operator also enters attributes of the part images of the facial expression image through the input unit 4. Then, data F0d of the key frame as shown in FIG. 4 are generated.

The image processing for the key frame will be described in detail below with reference to FIGS. 3 and 4.

As shown in FIG. 3, change points of the two eyes (four change points for each of the eyes) of the unit facial expression F0 are represented by X10-X80, and four change points of the mouth are represented by X90-X120. As shown in FIG. 4, coordinates of the change point X10 of the first eye (part pattern) shown in FIG. 3 are entered, an attribute of the part image is entered as “EYE1”, and the type of a line connecting to the next change point X20 is entered as “ELLIPSE”. The coordinates, the attribute, and the type of the connecting line of the change point X10 are registered as shown in FIG. 4.

Similarly, coordinates of the change points X20, X30, X40 of the first eye are entered, attributes of the part image are entered as “EYE1”, and the type of lines connecting to the next change points are entered as “ELLIPSE”. The coordinates, the attributes, and the types of the connecting lines of the change points X20, X30, X40 are registered as shown in FIG. 4.

Then, coordinates of the change points X50, X60, X70, X80 of the second eye are entered, attributes of the part image are entered as “EYE2”, and the type of lines connecting to the next change points are entered as “ELLIPSE”. The coordinates, the attributes, and the types of the connecting lines of the change points X50, X60, X70, X80 are registered as shown in FIG. 4.

Furthermore, coordinates of the change points X90, X100, X110, X120 of the mouth are entered, attributes of the part image are entered as “MOUTH”, and the type of lines connecting to the next change points are entered as “4 LINES SMOOTH”. The coordinates, the attributes, and the types of the connecting lines of the change points X90, X100, X110, X120 are registered as shown in FIG. 4.

In this manner, the data F0d of the key frame as shown in FIG. 4 are generated.

(S6) When the next frame is not the key frame, image processing for another frame is designated, then the image of the frame is displayed. The operator designates change points of the part patterns of the facial expression image of the frame through the coordinate input unit 3. Functions between the designated change points are calculated to generate facial expression transition data F1d-Fnd of the subordinate frames shown in FIG. 4.

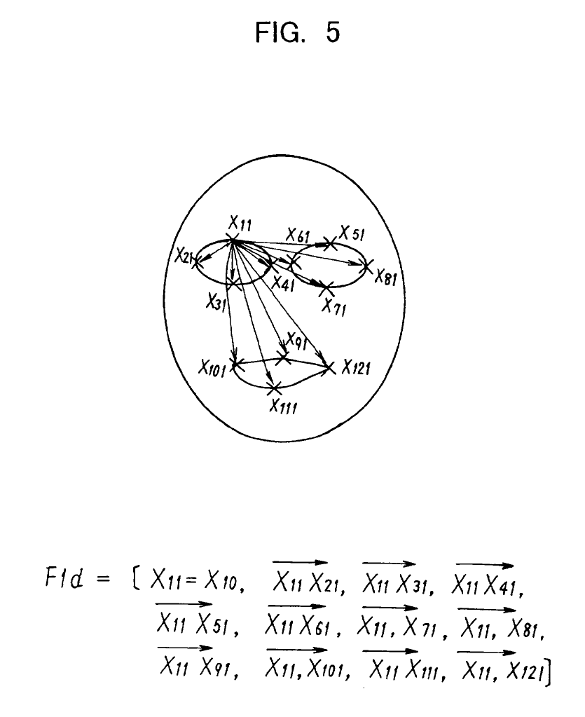

The facial expression transition data F1d-Fnd will be described in detail below with reference to FIGS. 5 through 8. As shown in FIGS. 5 through 8, the two eyes of the unit expressions F1-Fn are expressed by four change points (X11-X8n), and the mouth thereof are expressed by four change points (X91-X12n).

As shown in FIGS. 5 through 8, fixed points are designated for the respective unit facial expressions F1-Fn. The fixed points are set to change points X11-X1n of the first eye. Positional data of the change points are expressed by vectors (distance and direction) from the fixed points.

For example, with respect to the facial expression transition data F1d of the unit facial expression F1, as shown in FIG. 5, the data of the fixed point X11 is set to the change point X10 of the basic frame (unit facial expression) F0. The positions of the change points X21-X121 are expressed by vectors X11·X21-X11·X121 from the fixed point X11.

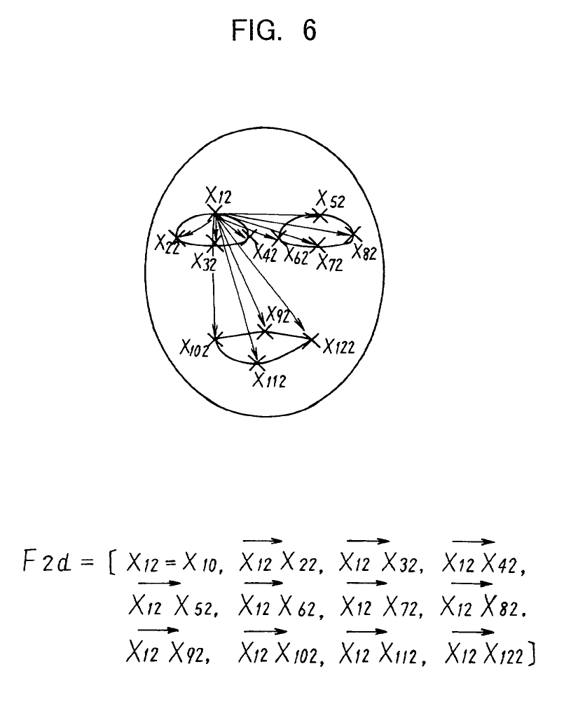

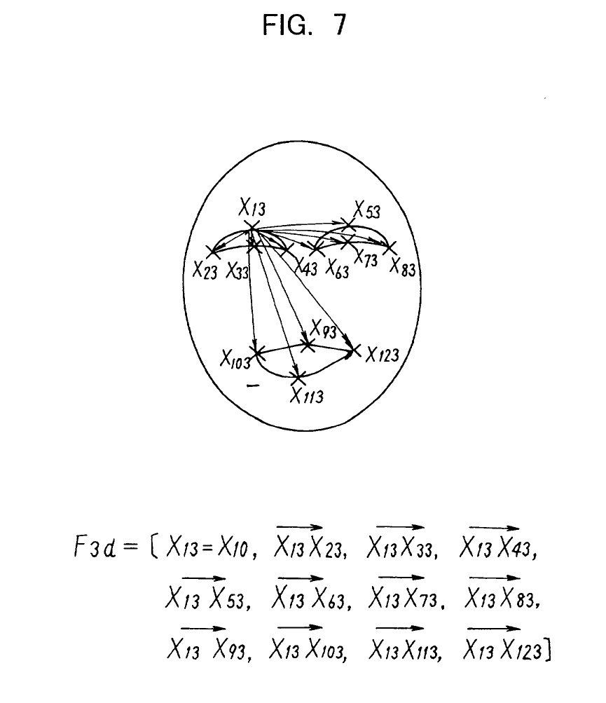

Similarly, with respect to the facial expression transition data F2d, F3d of the unit facial expressions F2, F3, as shown in FIGS. 6 and 7, respectively, the data of the fixed points X12, S13 are set to the change point X10 of the basic frame (unit facial expression) F0. The positions of the change points X22-X122, X23-X123 are expressed by vectors X12·X22-X12·X122, X13·X23-X13·X123 from the fixed points X12, X13.

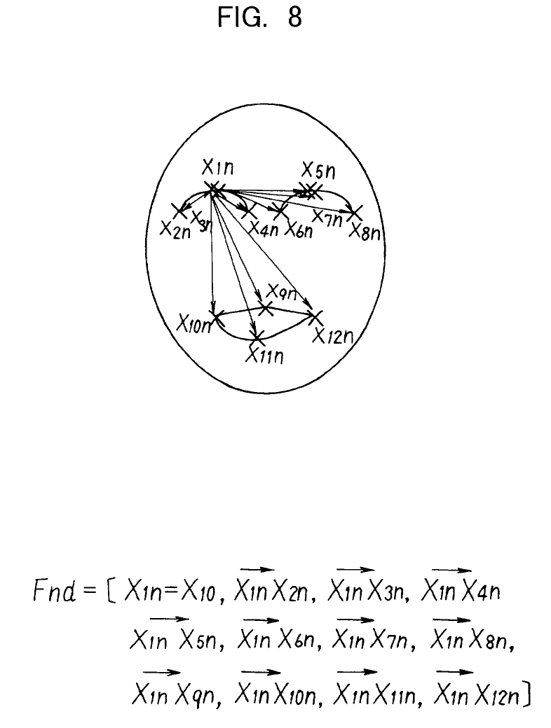

Furthermore, with respect to the facial expression transition data Fnd of the unit facial expression Fn, as shown in FIG. 8, the data of the fixed point X1n is set to the change point X10 of the basic frame (unit facial expression) F0. The positions of the change points X2n-X12n are expressed by vectors X1n·X2n-X1n·X12n from the fixed point X1n.

Each time the position of a change point is entered, the processing unit 5 calculates the distance and direction of the change point from the fixed point for thereby calculating a vector (function). In this fashion, the facial expression transition data (change point functions) of the respective unit facial expressions F1-Fn are generated.

(S7) If the entry of data is not finished, then control returns to step S4. If the entry of data is finished, then control proceeds to step S8.

(S8) The processing unit 5 stores the data F0d of the key frame F0 in the storage unit 6. The processing unit 5 stores the facial expression transition data (change point functions) F1d-Fnd of the respective unit facial expressions in the storage unit 6. The processing unit 5 also stores the number of constituent frames and the key frame number in the storage unit 6.

In this manner, a function table of the facial expression images (smile) shown in FIG. 3 is generated as shown in FIG. 4. In this function table, the image data of the key frame can be used to reproduce, by itself, the image of the key frame. The images of the subordinate frames can be reproduced by referring to the image data of the key frame. The data of the subordinate frames are expressed by functions (vectors) indicative of the relative positions of the change points. Since only the data of the change points and their relative positions are stored, the storage capacity required to store the images of the subordinate frames may be greatly reduced.

Specifically, a complex face image is expressed by change points and their interconnecting relationships, and subordinate frames are expressed by the relative positional relationship between the change points based on the data of a basic frame. Therefore, complex facial expressions can be expressed with a small storage capacity, and thus a wide variety of facial expressions can be expressed with a small storage capacity.

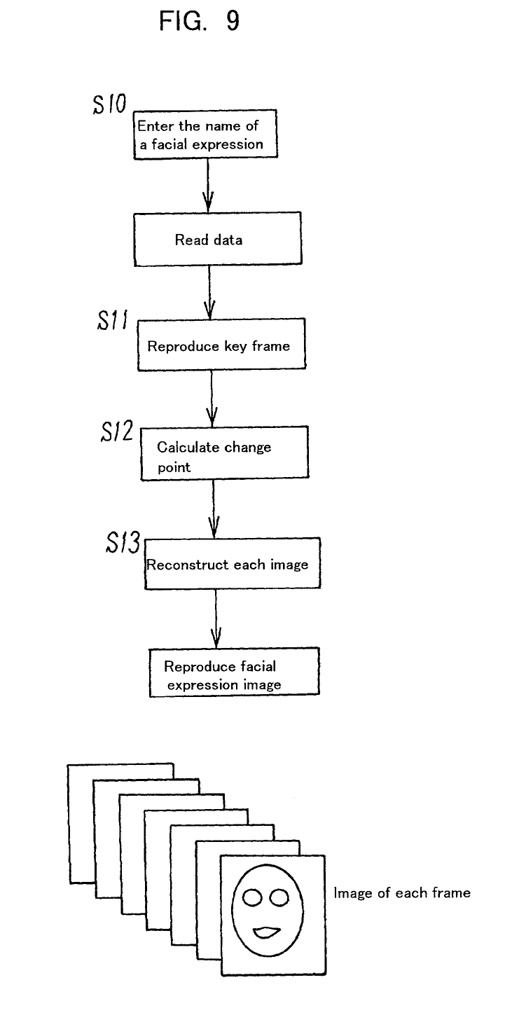

A reproducing process will be described below with reference to FIG. 9. In FIG. 9, numerals with a prefix “S” represent step numbers.

(S10) The name of a facial expression to be reproduced is entered. The processing unit 5 reads a function table (see FIG. 3) assigned to the entered name from the storage unit 6.

(S11) The key frame F0 is reproduced from the data F0d of the key frame in the function table. The data of the key frame defines the coordinates, attributes, and connecting relationships of the change points. Therefore, the image of the key frame can be reproduced by connecting the change points with the types of the connecting lines according to the attributes.

(S12) Then, the points of the change points of subordinate frames are calculated. As shown in FIG. 4, the data of the subordinate frames are defined by the position of the fixed point and the relative positional relationships (vectors) between the change points. Therefore, absolute positions of the respective change points can be calculated from the position of the fixed point and relative vectors from the fixed point.

(S13) The image data of a subordinate frame are reproducing using the attributes of the key frame and the connecting relationships. Specifically, the calculated change points of the subordinate frame are interconnected by the types of the connecting lines according to the attributes of the key frame for thereby reproducing the image of the subordinate frame. This process is carried out for each of the subordinate frames to reproduce the images of the subordinate frames.

In this manner, the image of the key frame and the images of the subordinate frames, which correspond to the entered name of the facial expression, can be reproduced. Specifically, after the image of the key frame is reproduced, the images of the subordinate frames are reproduced using the data of the key frame. Consequently, the images of the subordinate frames can be reproduced even though the data of the subordinate frames are expressed by the relative positional relationships from the fixed point.

The positions of the change points of the subordinate frames are indicated by the relative positions of the images of those frames with respect to the fixed point. Accordingly, for reproducing the images of the subordinate frames, coordinates of the change points of the subordinate frames can be calculated only from the coordinates of the fixed points of the subordinate frames. Therefore, the period of time required to reproduce the images of the subordinate frames may be reduced.

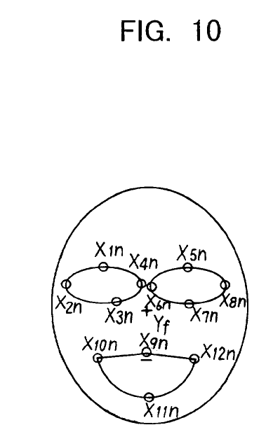

FIG. 10 illustrates another embodiment of the present invention.

In FIG. 10, a center-of-gravity point Yf is added to the position of the center of gravity of a face image, and the positions of change points X1n-X12n are expressed by relative positions (vectors) from the center-of-gravity point Yf.

Inasmuch as the position of the center-of-gravity point Yf remains unchanged in the unit facial expressions F0-Fn, the image data of subordinate frames can be generated without referring to the positions of the change points of the key frame when registering unit facial expression images. Consequently, the registering process is simplified and can be carried out at an increased speed.

If the positions of the change points X1n-X12n are the same as positions where the part patterns have a maximum curvature, then the change points can automatically be extracted from the contours of the part patterns at the time of registering facial expression images. Therefore, the operator can save the process of manually entering the change points. Since actual facial expression images are composed of many change points, it is highly effective to be able to save the process of manually entering the change points.

In addition to the above embodiments, the present invention may be modified as follows:

(1) While a smile has been described as an example of a facial expression image in the above embodiments, other facial expression images may also be registered and reproduced in the same manner as described above.

(2) While coordinates, attributes, and connecting relationships of change points have been illustrated as data of a key frame, coordinates between the change points may additionally be employed.

The present invention offers the following advantages:

(1) Since facial expression images of subordinate frames are reproduced from the relative positional relationships between change points of the subordinate frames and the data of a basic frame, the stored data of the subordinate frames may only be data indicative of the relative positional relationships between the change points. Accordingly, the storage capacity for storing facial expression images of subordinate frames may greatly be reduced.

(2) Because subordinate frames employ change points of part patterns of facial expression images, a wide variety of many facial expressions can be presented.

(3) The positions of change points of subordinate frames are represented as relative positions from the fixed points of the images of those frames. Consequently, for reproducing the images, coordinates of the change points of the subordinate frames can be calculated only from the coordinates of the fixed points of the subordinate frames. As a result, the time required to reproduce the images can be shortened.

Although certain preferred embodiments of the present invention have been shown and described in detail, it should be understood that various changes and modifications may be made therein without departing from the scope of the appended claims.

What is claimed is:

1. An apparatus for reproducing a subordinate frame representative of another facial expression image from a basic frame representative of a basic facial expression image, comprising:
storage means for storing data of the basic frame which represents shapes and positions of part patterns of said basic facial expression image, and data of the subordinate frame which represents a relative positional relationship between a plurality of change points of respective part patterns of the other facial expression image; and
reproducing means for reproducing the facial expression image of the subordinate frame from the relative positional relationship between the change points of the subordinate frame corresponding to a designated facial expression and the data of said basic frame.

2. An apparatus according to claim 1, wherein said data of said basic frame stored in said storage means comprises positions of the change points of the part patterns of said basic facial expression image and connecting relationships between said change points.

3. An apparatus according to claim 2, wherein said data of the subordinate frame stored in said storage means comprises relative positional relationships of movable points with respect to an immovable point of the other facial expression image.

4. An apparatus according to claim 3, wherein said data of the subordinate frame stored in said storage means has said immovable point composed of the position of a change point of said basic frame.

5. An apparatus according to claim 1, wherein said data of the subordinate frame stored in said storage means comprises information of the relative positional relationship represented by distances and directions between said change points.

6. An apparatus according to claim 1, wherein said facial expression images comprise two-dimensional face images.

7. An apparatus according to claim 1, wherein said data of the subordinate frame stored in said storage means comprises information of the relative positional relationship between change points where said part patterns have a maximum curvature.

8. A method of reproducing a subordinate frame representative of another facial expression image from a basic frame representative of a basic facial expression image, comprising the steps of:
generating data of the basic frame which represents shapes and positions of part patterns of said basic facial expression image;
generating data of the subordinate frame which represents a relative positional relationship between a plurality of change points of respective part patterns of the other facial expression image; and
reproducing the facial expression image of the subordinate frame from the relative positional relationship between the change points of the subordinate frame corresponding to a designated facial expression and the data of said basic frame.

9. A method according to claim 8, wherein said step of generating said data of the basic frame comprises the step of generating positions of the change points of the part patterns of said basic facial expression image and connecting relationships between said change points.

10. A method according to claim 9, wherein said step of generating said data of the subordinate frame comprises the step of generating relative positional relationships of movable points with respect to an immovable point of the other facial expression image.

11. A method according to claim 10, wherein said step of generating said data of the subordinate frame comprises the step of generating said immovable point composed of the position of a change point of said basic frame.

12. A method according to claim 8, wherein said step of generating said data of the subordinate frame comprises the step of generating the relative positional relationship represented by distances and directions between said change points.
